(19) United States
(12) Patent Application Publication
(10) Pub. No.: US 2008/0296104 A1
(43) Pub. Date: Dec. 4, 2008

(54) Brake clamping assembly

(76) Inventor: Chester Wen, Changhua County (TW)

Correspondence Address: Chester Wen, 235 Chung-Ho, Box 8-24, Taipei, TW

(21) Appl. No.: 11/807,609

(22) Filed: May 31, 2007

(51) Int. Cl. F16D 55/40

(52) U.S. Cl. 188/73.38

(57) ABSTRACT

A brake clamping assembly, comprises a cylinder body; an outer side of the cylinder body having an outer hole; the cylinder body having a hollow receiving space; and the receiving space having a claw; the claw is elastic; an inner brake pad being installed inside of the claw and the outer brake pad being installed at an outer side of the claw; each of the inner brake pad and outer brake pad having a braking block which is positioned to the claw; an inner side of the inner brake pad is installed with an inner piston assembly; the outer brake pad being installed with an outer piston assembly. A retaining pin passing through the cylinder body, the outer brake pad, the claw and the inner brake pad; and a clip serves to fix the retaining pin; furthermore.

### FIELD OF THE INVENTION

The present invention relates to brakes, and particularly to a brake clamping assembly with a stable structure and preferable having preferable oil sealing ability.

### BACKGROUND OF THE INVENTION

Disk type brakes have preferred effect for providing more power in braking. In disk type braking, a disk is installed to a wheel of a vehicle. The disk rotates with the wheel frame. A brake clamping assembly clamps the disk for decelerating the wheel.

In the disk type braking, the hub of a wheel is installed with a disk which is concentric to the wheel. The cylinder body of the clamping assembly serves to fix the disk. The cylinder body has an oil pressure tube for communicating oil to an oil cylinder. A braking pull will drive the oil in the cylinder and then a piston in the cylinder body will be driven. The piston further drives a braking sheet. The braking sheet will rub the disk to generate friction force to the disk so as to make the wheel decelerate.

In one prior art brake clamping assembly, the brake clamping assembly has an inner surface which rounds around a shaft line and has a penetrating hole. The surface has two trenches. Two pistons are received in the trenches. Each piston has an outer surface. Two oil sealings are installed to the outer surfaces of the pistons and are received in the trenches. Two retracting portions each has an inclined surface winding the shaft line and in the trenches. The inclined surface has one end near the shaft line and at a forwarding direction of the piston and another end far away from the shaft line and near the returning direction of the piston. Thereby in the forward movement of the piston, the oil sealing will be hindered by the inclined surface so as to deform and accumulate energy. By the deformation energy is released, the piston will resilient.

The prior art brake clamping assembly has two cylinder bodies. The pistons are installed conveniently from the outer sides to the inner sides. Practically, because the structure is unstable and braking oil is easy to drain out, the internal mechanism will be polluted by oil, even the braking mechanism is non-operated. Moreover, the structures of the two cylinder bodies are loosed. As a result, it is possible that some traffic accidents will occur.

Thus, there is an eager demand for a novel brake clamping assembly which can improve above mentioned defects so as to provide an effective and safety braking device.

### SUMMARY OF THE INVENTION

Accordingly, the primary object of the present invention is to provide a brake clamping assembly with a stable structure and preferable oil sealing ability.

To achieve above objects, the present invention provides a brake clamping assembly, comprises a cylinder body; an outer side of the cylinder body having an outer hole; the cylinder body having a hollow receiving space; and the receiving space having a claw; the claw is elastic; an inner brake pad being installed inside of the claw and the outer brake pad being installed at an outer side of the claw; each of the inner brake pad and outer brake pad having a braking block which is positioned to the claw; an inner side of the inner brake pad is installed with an inner piston assembly; the outer brake pad being installed with an outer piston assembly. A retaining pin passing through the cylinder body, the outer brake pad, the claw and the inner brake pad; and a clip serves to fix the retaining pin; furthermore.

The various objects and advantages of the present invention will be more readily understood from the following detailed description when read in conjunction with the appended drawing.

### BRIEF DESCRIPTION OF THE DRAWINGS

FIG. 1 is an exploded perspective view of the brake clamping assembly of the present invention.

FIG. 2 is an assembled schematic view of the brake clamping assembly of the present invention.

FIG. 3 is a schematic view showing that the present invention is assembled to a disk.

FIG. 4 is a schematic view showing the operation of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

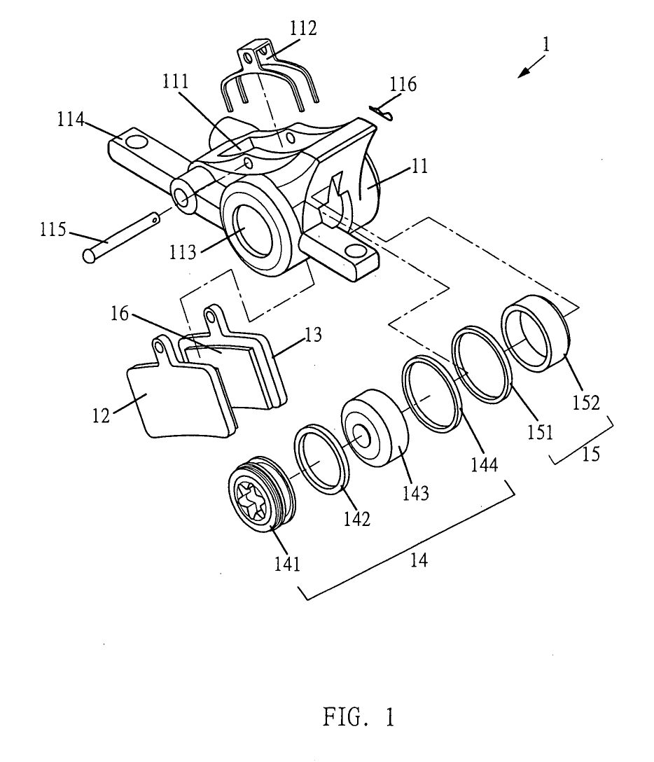

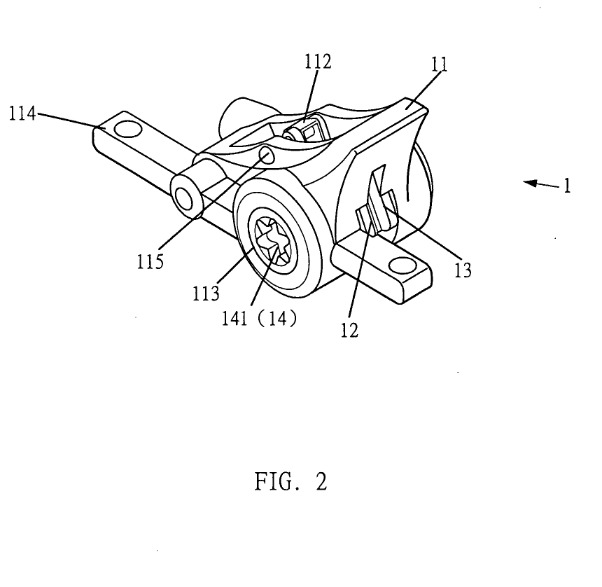

With referring to FIGS. 1, and 2, the structure of the present invention is illustrated. The present invention has the following elements.

A cylinder body 11 has an oil pressure tube 114 for adjusting braking oil therein. An outer side of the cylinder body 11 has an outer hole 113. The cylinder body 11 has a hollow receiving space 111.

The receiving space 111 has a claw 112. The claw 112 is elastic. An inner brake pad 13 is installed inside of the claw 112 and the outer brake pad 12 is installed at an outer side of the claw 112. Each of the inner brake pad 13 and outer brake pad 12 has a braking block 16 which is positioned to the claw 112. A retaining pin 115 passes through the cylinder body 11, the outer brake pad 12, the claw 112 and the inner brake pad 13. A clip 116 serves to fix the retaining pin 115. Furthermore, an inner side of the inner brake pad 13 is installed with an inner piston assembly 15. The outer brake pad 12 is installed with an outer piston assembly 14.

The inner piston assembly 15 has an inner oil sealing ring 151 and an inner piston 152. The inner piston 152 resists against the inner brake pad 13. The inner oil sealing ring 151 serves to tightly adhere the inner piston 152 to the inner brake pad 13 for sealing oil.

The outer piston assembly 14 has an outer oil sealing ring 144, an outer piston 143, an oil sealing ring 142 and a cover 141. The cover 141 is installed to the outer hole 113 of the cylinder body 11. The oil sealing ring 142 serves to tightly assembly the outer piston 143 to the outer brake pad 12 for sealing oil. The outer oil sealing ring 144 serves to seal the outer brake pad 12 for sealing oil in the receiving space 111.

In assembly, the inner piston 152 and the inner oil sealing ring 151 are installed in the receiving space 111. The cover 141, oil sealing ring 142, outer piston 143, and outer oil sealing ring 144 are installed in the receiving space 111 sequentially from an inner side to the outer side for preventing braking oil to drain out. The inner brake pad 13 and outer brake pad 12 are installed in the inner side and outer side of the receiving space 111. The claw 112 serves to buckle the braking blocks 16 of the inner brake pad 13 and outer brake pad 12. Then the retaining pin 115 passes through the outer brake pad 12, claw 112, and inner brake pad 13. The clip 116 serves to fix the retaining pin 115. Thus the assembly of the brake clamping assembly of the present invention is complete. Braking oil is filled into the oil pressure tube 114. By controlling the pressure of the oil, the inner piston 152 and the outer piston 143 are pushed. Thus the inner brake pad 13 and outer brake pad 12 are pushed by the inner piston 152 and the outer piston 143. The braking blocks 16 will clamp a disk 2.

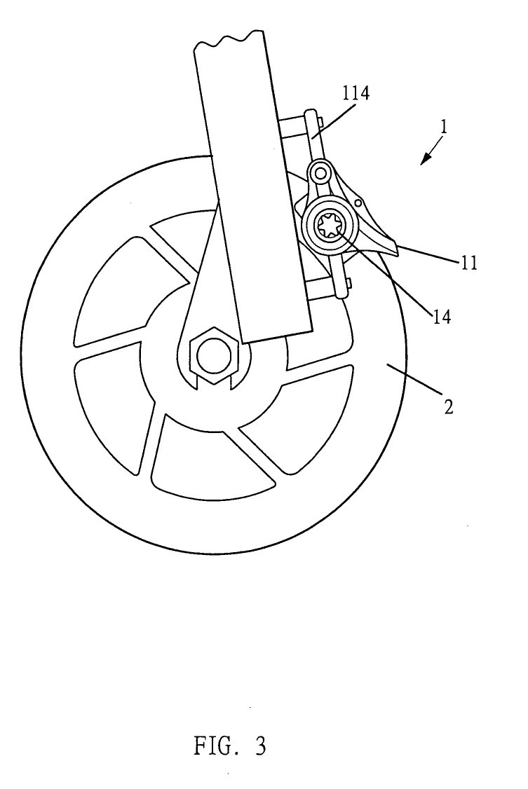

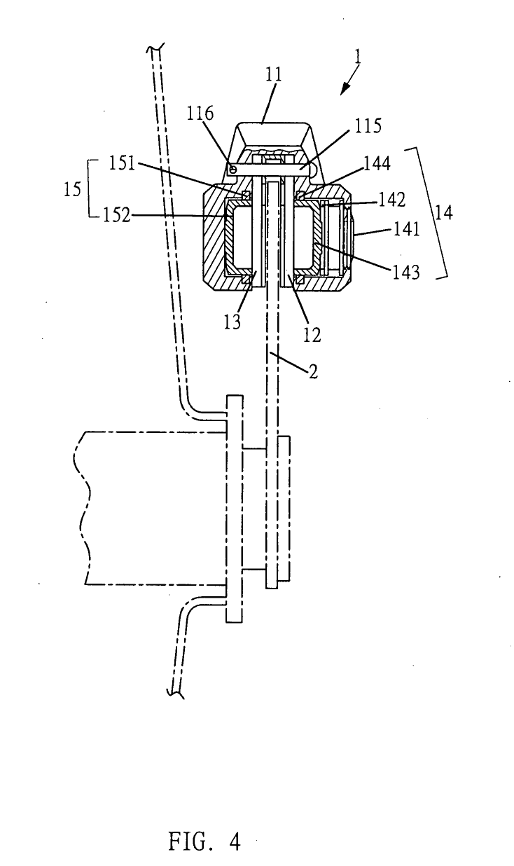

Referring to FIGS. 3 and 4, in the disk like braking device, a disk 2 is installed near a wheel. The disk 2 is installed between the inner brake pad 13 and outer brake pad 12. Oil is filled into the cylinder body 11 through the oil pressure tube 114. When the user to press the barking handle, the oil pressure tube 114 will protrude out to increase the pressure in the cylinder body 11. The inner piston 152 and outer piston 143 will compress the inner brake pad 13 and outer brake pad 12. The elastic claw 112 will be compressed so that the braking blocks 16 of the inner brake pad 13 and outer brake pad 12 will extrude the disk 2. Referring to FIG. 4, by the friction force from the braking blocks 16 to the disk 2, the wheel will decelerate.

When the braking handle is released, the pressure to the oil pressure tube 114 is reduced, the pressure of the braking oil in the cylinder body 11 will reduce at the same time. The claw 112 in the cylinder body 11 is elastic. By the elastic returning force of the claw 112, the inner brake pad 13 and the outer brake pad 12 are extended outwards. The inner brake pad 13 and outer brake pad 12 will push the inner piston 152 and outer piston 143 away. Thus no friction force is applied to the disk 2. The wheel can move normally.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A brake clamping assembly, comprising:
a cylinder body; an outer side of the cylinder body having an outer hole; the cylinder body having a hollow receiving space; and
the receiving space having a claw; the claw is elastic; an inner brake pad being installed inside of the claw and the outer brake pad being installed at an outer side of the claw; each of the inner brake pad and outer brake pad having a braking block which is positioned to the claw; an inner side of the inner brake pad is installed with an inner piston assembly; the outer brake pad being installed with an outer piston assembly.

2. The brake clamping assembly as claimed in claim 1, wherein a retaining pin passes through the cylinder body, the outer brake pad, the claw and the inner brake pad; and a clip serves to fix the retaining pin; furthermore.

3. The brake clamping assembly as claimed in claim 1, wherein the inner piston assembly has an inner oil sealing ring and an inner piston 152; the inner piston 152 resists against the inner brake pad 13; and the inner oil sealing ring 151 serves to tightly adhere the inner piston 152 to the inner brake pad 13 for sealing oil.

4. The brake clamping assembly as claimed in claim 1, wherein the outer piston assembly has an outer oil sealing ring, an outer piston, an oil sealing ring and a cover; and the cover is installed to the outer hole of the cylinder body; the oil sealing ring serves to tightly assembly the outer piston to the outer brake pad for sealing oil; the outer oil sealing ring serves to seal the outer brake pad for sealing oil in the receiving space.

5. The brake clamping assembly as claimed in claim 1, wherein the cylinder body has an oil pressure tube for adjusting braking oil therein.
